(19) United States
(12) Patent Application Publication
(10) Pub. No.: US 2022/0058599 A1
(43) Pub. Date: Feb. 24, 2022

(54) SETTLEMENT OPERATION SUPPORT SYSTEM AND SETTLEMENT OPERATION SUPPORT METHOD

(71) Applicant: HITACHI, LTD., Chiyoda-ku, Tokyo (JP)

(72) Inventors: Toshiki TANIGUCHI, Chiyoda-ku, Tokyo (JP); Tatsurou TSUBONE, Chiyoda-ku, Tokyo (JP); Susumu KOBAYASHI, Chiyoda-ku, Tokyo (JP); Masayuki OYAMATSU, Chiyoda-ku, Tokyo (JP)

(73) Assignee: HITACHI, LTD., Chiyoda-ku, Tokyo (JP)

(21) Appl. No.: 17/299,069

(22) PCT Filed: Nov. 29, 2019
(86) PCT No.: PCT/JP2019/046740

§ 371 Date: Jun. 2, 2021

(30) Foreign Application Priority Data
Dec. 6, 2018 (JP) 2018-228913

(51) Int. Cl. G06Q 20/10; G06Q 30/06; G06Q 10/08

(52) U.S. Cl. CPC G06Q 20/102; G06Q 2220/00; G06Q 10/08; G06Q 30/0637

(57) ABSTRACT

A settlement operation support system for a distributed ledger system 5 including a plurality of nodes representing a plurality of organizations, respectively, at least a prescribed node 10 out of the nodes includes: a storage unit 11 configured to store a distributed ledger 110; and a computation unit 14 configured to execute processing to receive a transaction for a settlement operation associated with order placement and acceptance between prescribed organizations out of the organizations, and to store the transaction in the distributed ledger 110 after building a prescribed consensus in the distributed ledger system 5, processing to manage a status in each of procedures in the settlement operation as state information 112 of the distributed ledger 110, and processing to perform reconciliation processing of a relevant order placement or acceptance action in a case where a status of an amount of settlement in the state information 112 becomes credit completed.

### TECHNICAL FIELD

The present invention relates to a settlement operation support system and a settlement operation support method.

### BACKGROUND ART

There is a service platform for supporting a business collaboration focused on order placement and acceptance operations among clients and partners of enterprises such as buyers and suppliers that form a supply chain.

In this service platform, various application services (SaaS) corresponding to business types, operations, tasks, and the like are provided as places for business trading on the Internet. For example, the aforementioned order placement and acceptance operations can be carried out efficiently and seamlessly with the statuses thereof being managed.

However, settlement operations associated with the aforementioned order placement and acceptance operations have been out of the scope of the above-mentioned service platform. Accordingly, regarding the settlement operations, related parties tend to proceed with conventional processing while directly communicating with each other.

Given the situation, as a conventional technique concerning promotion of efficiency and the like of the settlement operations, there is disclosed a credit confirmation system (see PTL 1) which includes an enterprise center installed at each enterprise and provided with an account receivable information database that stores account receivable information concerning accounts receivable, a financial institution center that manages account information, and a payment acceptance device that requests the financial institution center to pay for an account receivable in response to a request from a user, for example. Here, the enterprise center provides collation information regarding the account receivable information designated by a prescribed request in response to the prescribed request which is from the payment acceptance device that has accepted a payment request from the user, and transmits the collation information to the payment acceptance device. The payment acceptance device incorporates the collation information acquired from the enterprise center in response to the input for the payment request by the user into a fund transfer request telegraph for requesting a fund transfer, and transmits the telegraph to the financial institution center. The financial institution center performs credit processing to a prescribed account in response to the fund transfer request telegraph received from the payment acceptance device, and generates credit information containing the collation information contained in the fund transfer request telegraph. The enterprise center acquires the credit information from the financial institution center, and performs prescribed reconciliation processing concerning the relevant account receivable information with reference to the account receivable information database while using the collation information contained in the credit information as a key.

Meanwhile, there is also disclosed a settlement management system (see PTL 2), for instance, which includes identification number providing means for providing billing statement data being prepared for respective billing statements with an identical transfer identification number for each payment due date of the respective billing statements, transfer data generating means for summing up billing amounts in the billing statements provided with the identical transfer identification number and generating transfer data in which the summed billing amounts are associated with the transfer identification number, and reconciliation processing means for performing reconciliation processing by collating either the billing statement data or the transfer data having the transfer identification number with credit information on credits actually made on each payment due date.

There is also disclosed a trading action support server (see PTL 3) to support a trading action between a seller and a buyer, for instance. The trading action support server includes: a trading action data storage part that stores information for associating delivery data of the seller including item identification information, item quantity, and item unit price and being expressed in an expression format used in processing by the seller, with delivery data of the buyer including item identification information, item quantity, and item unit price and being expressed in an expression format used in processing by the buyer; a seller data receiving part that receives the delivery data of the seller generated due to the trading action from a terminal of the seller; a buyer data receiving part that receives the delivery data of the buyer generated due to the trading action from a terminal of the buyer; a matching part that associates the delivery data of the seller received by the seller data receiving part with the delivery data of the buyer received by the buyer data receiving part by using the trading action data storage part; and an output part that outputs at least any of the delivery data of the seller and the delivery data of the buyer associated with each other by the matching part to at least one of the terminals of the seller and buyer.

### CITATION LIST

### Patent Literature

[PTL 1] Japanese Patent Application Laid-open Publication No. 2001-250074
[PTL 2] Japanese Patent Application Laid-open Publication No. 2002-216039
[PTL 3] Japanese Patent Application Laid-open Publication No. 2003-233765

### SUMMARY OF INVENTION

### Technical Problem

Meanwhile, in the settlement operations that take place separately from the above-described service platform, persons in charge at the respective enterprises carry out operations to confirm payment as well as credit and to perform reconciliation for each of an enormous number of order placement and acceptance actions. The larger a scale of the enterprise is or the larger the number of the order placement and acceptance actions is, the greater burden the operations involve, thus leading to very cumbersome paperwork.

Each of the payment, credit, and reconciliation operations is supposed to be carried out after confirmation of the statuses of other operations or the like that trigger the relevant operation. Nevertheless, the persons in charge at the respective parties of trading are not in a position to carry out the confirmation efficiently and reliably, and are prone to carry out the confirmation by making contact with each other as needed. The work efficiency and instantaneity of such an operation or accuracy of a confirmation result is far from favorable.

In addition, if a management system for the information on the status is inadequate, there is also a possibility of damaging a fair trading environment due to the occurrence of an inappropriate situation such as falsification.

Given the situation, it is an object of the present invention to provide a technique for managing a status of a prescribed event concerning a settlement operation thoroughly, efficiently, and with proper instantaneity between related parties, thereby improving efficiency of the settlement operation.

### Solution to Problem

A settlement operation support system of the present invention to solve the above object for a distributed ledger system including a plurality of nodes representing a plurality of organizations, respectively, at least a prescribed node out of the nodes comprises: a storage unit configured to store a distributed ledger; and a computation unit configured to execute processing to receive a transaction for a settlement operation associated with order placement and acceptance between prescribed organizations out of the organizations, and to store the transaction in the distributed ledger after building a prescribed consensus in the distributed ledger system, processing to manage a status in each of procedures in the settlement operation as state information of the distributed ledger, and processing to perform reconciliation processing of a relevant order placement or acceptance action in a case where a status of an amount of settlement in the state information becomes credit completed.

A settlement operation support method of this invention for a distributed ledger system including a plurality of nodes representing a plurality of organizations, respectively, in which at least a prescribed node out of the nodes includes a storage unit configured to store a distributed ledger, the method comprises executing, in the prescribed node: processing to receive a transaction for a settlement operation associated with order placement and acceptance between prescribed organizations out of the organizations, and to store the transaction in the distributed ledger after building a prescribed consensus in the distributed ledger system, processing to manage a status in each of procedures in the settlement operation as state information of the distributed ledger, and processing to perform reconciliation processing of a relevant order placement or acceptance action in a case where a status of an amount of settlement in the state information becomes credit completed.

### Advantageous Effects of Invention

According to the present invention, it is possible to manage a status of a prescribed event concerning a settlement operation thoroughly, efficiently, and with proper instantaneity between related parties, and thus to improve efficiency of the settlement operation.

### BRIEF DESCRIPTION OF DRAWINGS

FIG. 1 is a network configuration diagram including a settlement operation support system of an embodiment of the present invention.

FIG. 2 is a diagram showing a hardware configuration example of the settlement operation support system of the embodiment.

FIG. 3 is a diagram showing a first flow example of a settlement operation support method of the embodiment.

FIG. 4 is a diagram showing a first screen example of the embodiment.

FIG. 5 is a diagram showing a second screen example of the embodiment.

FIG. 6 is a diagram showing a third screen example of the embodiment.

FIG. 7 is a diagram showing a fourth screen example of the embodiment.

FIG. 8 is a diagram showing a fifth screen example of the embodiment.

FIG. 9 is a diagram showing a sixth screen example of the embodiment.

FIG. 10 is a diagram showing a second flow example of the settlement operation support method of the embodiment.

FIG. 11 is a diagram showing a seventh screen example of the embodiment.

FIG. 12 is a diagram showing a third flow example of the settlement operation support method of the embodiment.

### DESCRIPTION OF EMBODIMENTS

### ———Concerning Distributed Ledger Technology———

A distributed ledger technology has come into being as a P2P (Peer-to-Peer) direct trading method between users to replace trading through a centralized organization (a financial institution and a government, for example) which has heretofore been carried out.

As the aforementioned technique, there is a technique to conduct settlement actions without requiring the centralized organization such as a bank but instead by using a virtual currency, for example. In this technique, trading data (hereinafter a transaction) on a P2P network is subjected to determination of legitimacy by using a node called a miner, and then confirmation processing is carried out by means of a task to calculate a specific hash value called proof of work.

The transactions confirmed in this process are compiled into one block and registered with a distributed ledger called a blockchain. Note that a system formed from the nodes each holding the above-mentioned distributed ledger is referred to as a distributed ledger system.

Here, each transaction handled by a settlement operation support system 10 of an embodiment of the present invention is assumed to be one associated with a settlement operation of an order placement or acceptance action that takes place between participants (a buyer enterprise and a seller enterprise) of a supply chain. Accordingly, the transactions are issued when various procedures in the settlement operation are carried out by the respective nodes, and are registered with the distributed ledgers after building an appropriate consensus among the nodes.

Main features of the blockchain include: (1) in the trading between the participants on the distributed ledger system, the trading is confirmed by the consensus building or an approval between (arbitrary or specific) participants instead of a centralized organization; (2) multiple transactions are compiled into blocks and recorded on the distributed ledger in a concatenated fashion and then the continuous blocks are subjected to hash calculation so as to make falsification virtually impossible; and (3) all the participants are enabled to confirm the trading by allowing all the participants to hold the identical ledger data in the distributed ledgers.

Due to the above-described features, the distributed ledger technology as typified by the blockchain is under consideration as a scheme for managing/sharing reliable data and for enforcing/managing trading based on a contract, which is to be applied to a wide range of fields such as a financial field and the IoT (Internet of Things).

The existence of a smart contract is cited as one of those examples. The smart contract is also referred to as a digitalized contract (a contract formed into a software program), which is implemented by describing processing such as input and output of ledger data in the form of a program. Each of the nodes in the distributed ledger system executes the above-mentioned smart contract while building a mutual consensus, and updates each ledger data depending on a result of execution of the contract and so forth.

Here, some terms will be defined as stated below prior to the description of the embodiment. First, the distributed ledger is a distributed database characterized in that the ledger data that is treated among multiple nodes (distributed ledger nodes) forming the distributed ledger system is securely shared. The above-mentioned distributed ledger is also referred to as a blockchain.

In the meantime, among modes of the above-described distributed ledger system, a permissioned type (also called a consortium type) is assumed to be used herein because the participants in the distributed ledger system in this embodiment are enterprises such as buyer enterprises and supplier enterprises that form the supply chain, which are users that undergo usage registration for the aforementioned service platform (the existing service platform that supports the business collaboration focused on order placement and acceptance operations). Needless to say, this assumption is merely an example and other modes of the distributed ledger system may be applied as appropriate. Meanwhile, element technologies including a hash chain and a consensus protocol are used in the distributed ledger system for the purpose of the aforementioned data sharing.

In the meantime, the ledger data held in each distributed ledger mentioned above can adopt various data structures such as RDB (Relational DataBase) and KVS (Key-Value Store) as its data structure as appropriate. Such a data structure can be regulated by the users of the distributed ledger system.

Here, in the distributed ledger management using the blockchain, one usually needs to trace the blockchain in order to acquire a (or the newest) state (for example, details as well as an unpaid amount of a billing registration, payment procedures, and details as well as an unpaid amount of credit, and the like in the case of the settlement operation). However, this brings about poor processing efficiency. Accordingly, there is a method (such as “Hyperledger Fabric”, [online], [retrieved on Mar. 31, 2017, the Internet <URL: http://hyperledger-fabric.readthedocs.io/en/latest/>) of caching the newest state information separately from the blockchain.

In this regard, this embodiment also assumes the management of the newest state information on the distributed ledger. For example, the state information is managed in the above-described KVS data structure of linking a status of settlement processing at each stage of an order placement or acceptance action by using a billing statement ID of the action as a key.

In this way, the nodes of the distributed ledger system can acquire the status of the settlement processing of the order placement or acceptance action by using the billing statement ID of the action as the key, for example. The nodes update this state information every time the transaction is issued and stored along the processing in accordance with a settlement operation support method of this embodiment.

Meanwhile, the above-mentioned smart contract is assumed to be a program that describes processing concerning input and output of the ledger data, and so forth. The smart contract is installed on the node (a distributed ledger node) that belongs to the distributed ledger system and is executed at an appropriate timing.

The nodes that execute the smart contract are not necessarily all the nodes that belong to the distributed ledger system. Nonetheless, all the nodes that belong to the distributed ledger system update their own ledger data in accordance with a result of execution of the smart contract.

Meanwhile, the transaction is each procedure of the processing to be carried out by each of the above-mentioned nodes by executing the smart contract in conjunction with one another based on a consensus protocol and the like. Examples of the transaction include reference to the ledger data, updating of the ledger data, and so forth.

The transaction includes arguments (request parameters). Examples of such a transaction argument include a reference target data key (namely, the billing statement ID and the like), an updating target data key, and a value after updating.

Note that the description concerning the distributed ledger technology explained above will not be repeated in the following description. Accordingly, the specific description and illustration concerning the distributed ledger technology will be omitted as appropriate unless required.

### ———Network Configuration———

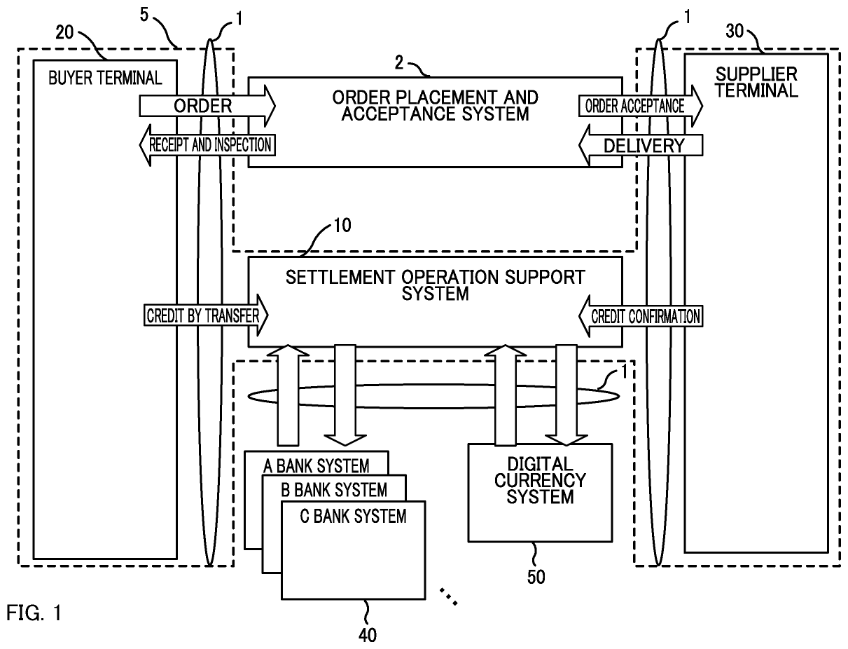

An embodiment of the present invention will be described below in detail by using the drawings. FIG. 1 is a network configuration diagram including the settlement operation support system 10 of this embodiment.

The settlement operation support system 10 shown in FIG. 1 is a computer system which manages a status of a prescribed event concerning the settlement operation thoroughly, efficiently or with proper instantaneity between related parties, and thus improves efficiency of the settlement operation.

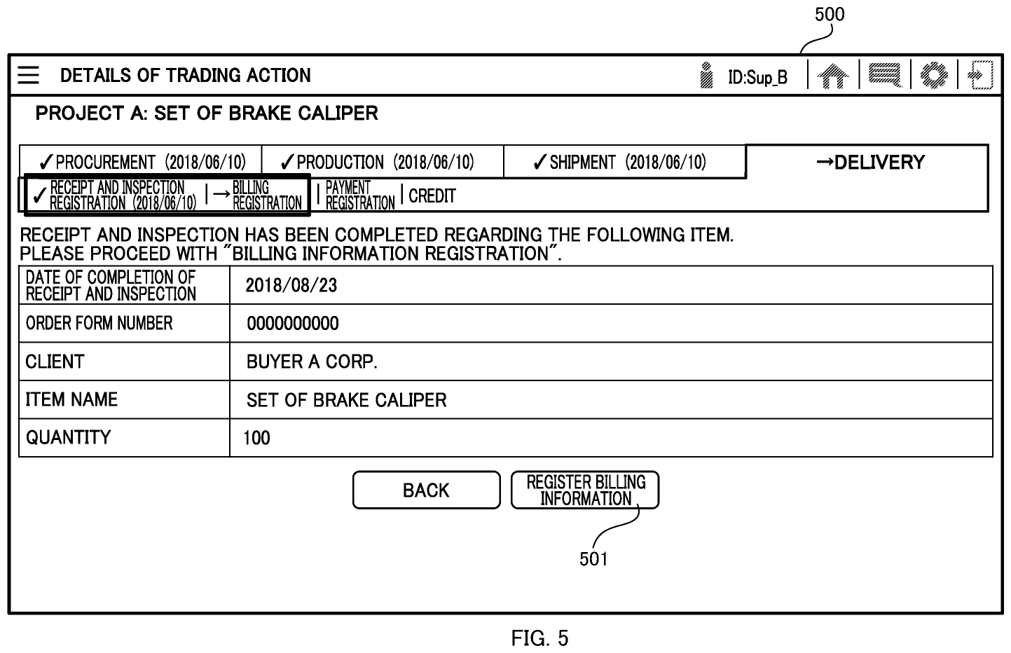

Users of a distributed ledger system 5 shown in FIG. 5, or in other words, the users having order placement and acceptance actions are a buyer and a supplier that form the supply chain, for example.

These enterprises operate the nodes, respectively. Among them, a node of the buyer enterprise will be referred to as a buyer terminal 20 and a node of the supplier enterprise will be referred to as a supplier terminal 30. In addition, the buyer terminal 20 and the supplier terminal 30 can communicate with each other through an appropriate network 1 such as the Internet.

Meanwhile, the buyer terminal 20 and the supplier terminal 30 are terminals that can access an order placement and acceptance system 2 (the service platform), which is a platform that performs the above-described order placement and acceptance operations, after undergoing prescribed authentication processing. That is to say, in the order placement and acceptance system 2, the buyer enterprise places an order of materials and the like with the supplier enterprise by operating the buyer terminal 20 while the supplier enterprise accepts the order through the supplier terminal 30. Then, the supplier enterprise delivers the ordered materials and the like to the buyer enterprise and seeks receipt and inspection thereof.

The settlement operation support system 10 of this embodiment receives notification from the order placement and acceptance system 2, for example, regarding an action that the buyer enterprise has completed receipt and inspection out of the order placement and acceptance actions to be processed by the order placement and acceptance system 2. Taking this opportunity, the settlement operation support system 10 starts necessary processing.

This settlement operation support system 10 has an aspect of a management system that leads the settlement operation support method as described above. The settlement operation support system 10 is also one of the nodes (distributed ledger nodes) in the distributed ledger system 5. In this case, the settlement operation support system 10 is capable of carrying out a series of processes including issuance of the transaction triggered by the processing of its own, consensus building, storage in the distributed ledger, and the like while collaborating with the buyer terminal 20 and the supplier terminal 30 as appropriate.

Meanwhile, upon receipt of a credit confirmation instruction from a user or in response to a status of a payment procedure of an amount of settlement in the state information, the settlement operation support system 10 inquires at an appropriate financial institution system such as a bank system 40 and a digital currency system 50 as to whether or not credit in a certain amount (concerning a certain billing statement) from the buyer enterprise to the supplier enterprise has been made. When the credit is confirmed, the settlement operation support system 10 issues a transaction for credit completion concerning the settlement operation on the corresponding billing statement, stores the transaction in the distributed ledger after building the consensus, and meanwhile, updates the status of the state information with “credit completed”.

Alternatively, for example, upon receipt of a request for procedures of a payment in a certain amount (credit processing) from the buyer terminal 20 to the supplier enterprise regarding a certain billing statement, the settlement operation support system 10 instructs the aforementioned appropriate financial institution system such as the bank system 40 and the digital currency system 50 to perform the credit processing in accordance with details indicated in the above-mentioned billing statement. The settlement operation support system 10 acquires a result of the credit processing corresponding to this instruction from the financial institution system. When the completion of the credit processing is confirmed, the settlement operation support system 10 issues the transaction for credit completion concerning the settlement operation on the corresponding billing statement, stores the transaction in the distributed ledger after building the consensus, and meanwhile, updates the status of the state information with “credit completed”.

As described above, the operation to update the status in the state information with “credit completed” corresponds to reconciliation processing on the relevant order placement or acceptance action. In other words, this operation means that the required settlement operation has been completed after undergoing the billing registration of the relevant order placement or acceptance action, the registration of the payment procedures, and the credit processing.

### ———Hardware Configuration———

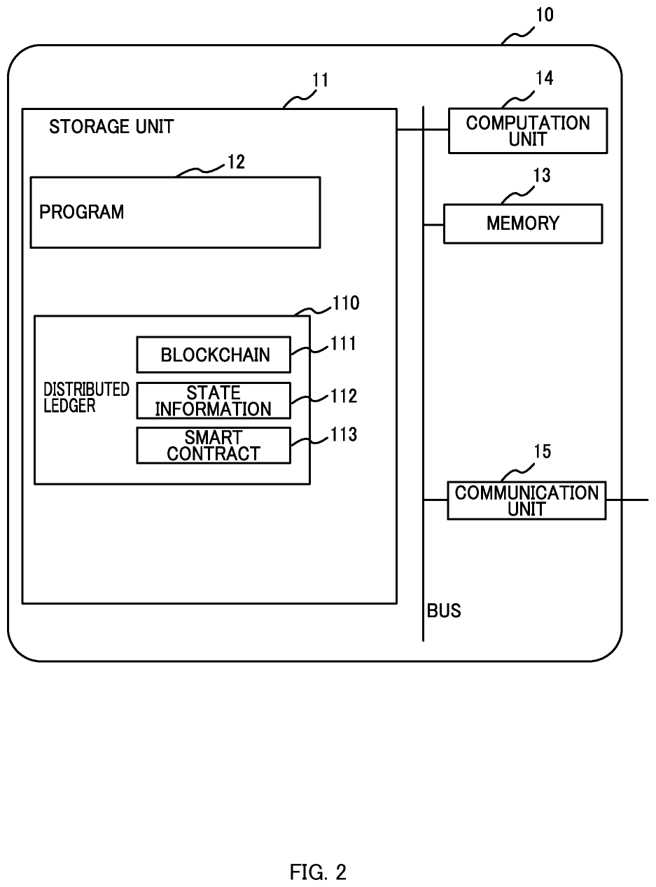

The settlement operation support system 10 has the following hardware configuration. FIG. 2 is a diagram showing a hardware configuration example of the settlement operation support system 10 of this embodiment.

The settlement operation support system 10 in this case includes a storage unit 11 formed from an appropriate non-volatile storage element such as an SSD (Solid State Drive) and a hard disk drive, a memory 13 formed from a volatile storage element such as a RAM, a computation unit 14 such as a CPU that retrieves a program 12 held in the storage unit 11, loads the program 12 on the memory 13 or the like, then executes the program 12 to perform overall control of the device itself, and also performs various determinations, calculations, and control processing, and a communication unit 15 that is coupled to the network 1 and handles processing for communication with other devices.

Note that the settlement operation support system 10 may include an input unit that accepts key input or voice input from the user, and an output unit such as a display device to display processing data when needed.

Here, in addition to the program 12 for implementing functions necessary for the settlement operation support system 10 of this embodiment, at least a distributed ledger 100, a blockchain 111, state information 112, and a smart contract 113 are stored in the storage unit 11.

The hardware configuration of the settlement operation support system 10 described above also applies to the buyer terminal 20 and the supplier terminal 30.

### ———Execution Example of Settlement Operation Support Method———

Actual procedures of a settlement operation support method of this embodiment will be described below based on the drawings. Various operations corresponding to the settlement operation support method described below are implemented by programs that are read out by the nodes such as the settlement operation support system 10, the buyer terminal 20, the supplier terminal 30, and the like, loaded on the memories and the like, and executed. Moreover, the programs are formed from codes for performing the various operations to be described below.

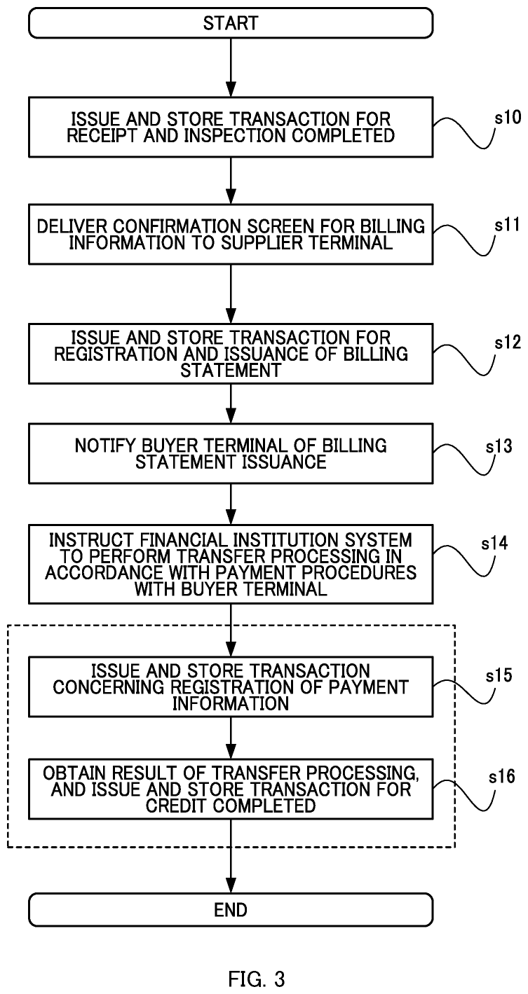

FIG. 3 is a diagram showing a first flow example of the settlement operation support method of the embodiment. Here, as an example of a trigger for starting the flow, the settlement operation support system 10 is assumed to have received notification “receipt and inspection completed” from the order placement and acceptance system 2 and the buyer terminal 20 concerning a certain order placement or acceptance action.

Naturally, this notification includes various information items that an order placement or acceptance contract may contain, namely, identification information (order form number, for example), action name/item name, amount of order acceptance, scheduled amount of credit, scheduled date of credit, buyer enterprise, supplier enterprise, detailed payment units, and the like concerning the order placement or acceptance action.

Therefore, regarding the order placement or acceptance action related to the received notification “receipt and inspection completed” as mentioned above, the settlement operation support system 10 issues the transaction concerning the notification and stores the transaction in the distributed ledger 110 after building the consensus (s10). Meanwhile, in s10, the settlement operation support system 10 stores the information concerning this transaction in the state information 112.

Here, respective pieces of information stored in the state information 112 are subjected to access control while being segmented depending on values of stakeholders such as the buyer enterprise and the supplier enterprise, and are delivered to the nodes of the stakeholders, that is, to the buyer terminal 20 and the supplier terminal 30. In other words, each of the buyer terminal 20 and the supplier terminal 30 can view only the state information 112 concerning the order placement or acceptance action that the each is involved in.

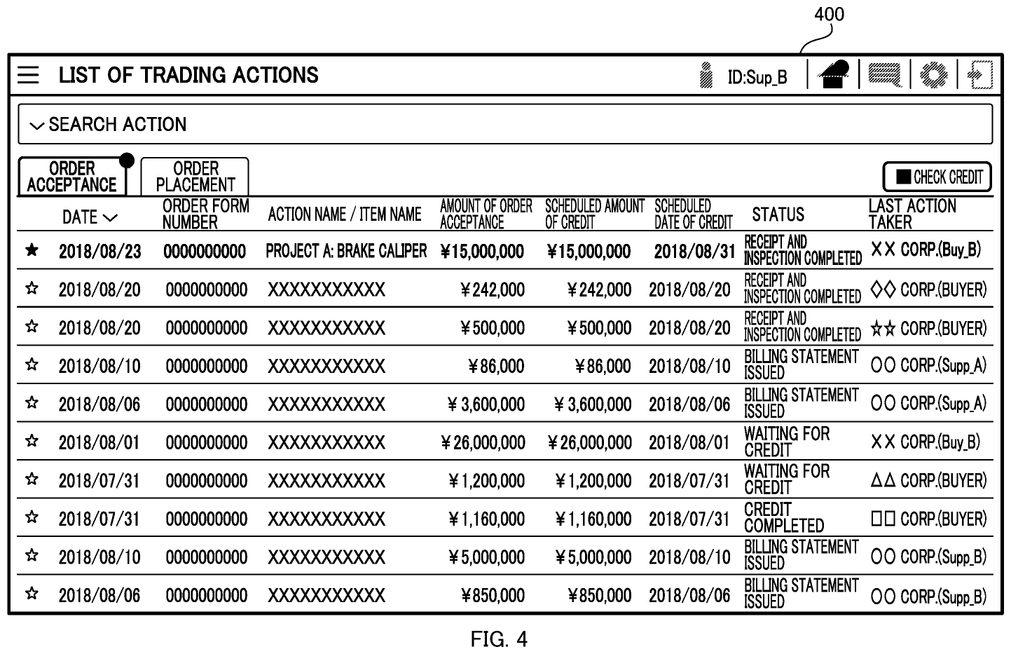

How the state information 112 is viewed is illustrated in a list screen 400 of trading actions in FIG. 4. This list screen 400 has such an interface configuration that enables selection of one of two sheets of “order acceptance” and “order placement” by using tabs. In other words, this configuration is adapted to the situation in which each stakeholder being the enterprise can be either the buyer enterprise or the supplier enterprise depending on the position in the order placement or acceptance.

In the meantime, each sheet is formed from records containing items including date, order form number, action name/item name, scheduled date of credit, status, last action taker, and so forth.

In the case of the aforementioned example, the record on the “order acceptance” sheet including the items of: date “2018/8/23”; order form number “0000001”; action name/item name “project A: brake caliper”; scheduled date of credit “2018/8/31”; status “receipt and inspection completed”; and last action taker “XX Corp. (Buy B)” corresponds to one stored in the state information 112 in response to the notification “receipt and inspection completed”.

Accordingly, a person in charge (a person in charge at the supplier enterprise as for the position) who is viewing this list screen 400 clicks the relevant record, confirms details of the receipt and inspection (FIG. 5: a confirmation screen 500 for the inspection details), and then clicks a registration button 501 for billing information by operating the supplier terminal 30, for example. Here, it is also possible to adopt an aspect of registering multiple receipt and inspection-completed actions in a lump as a single piece of billing information on the supplier enterprise side.

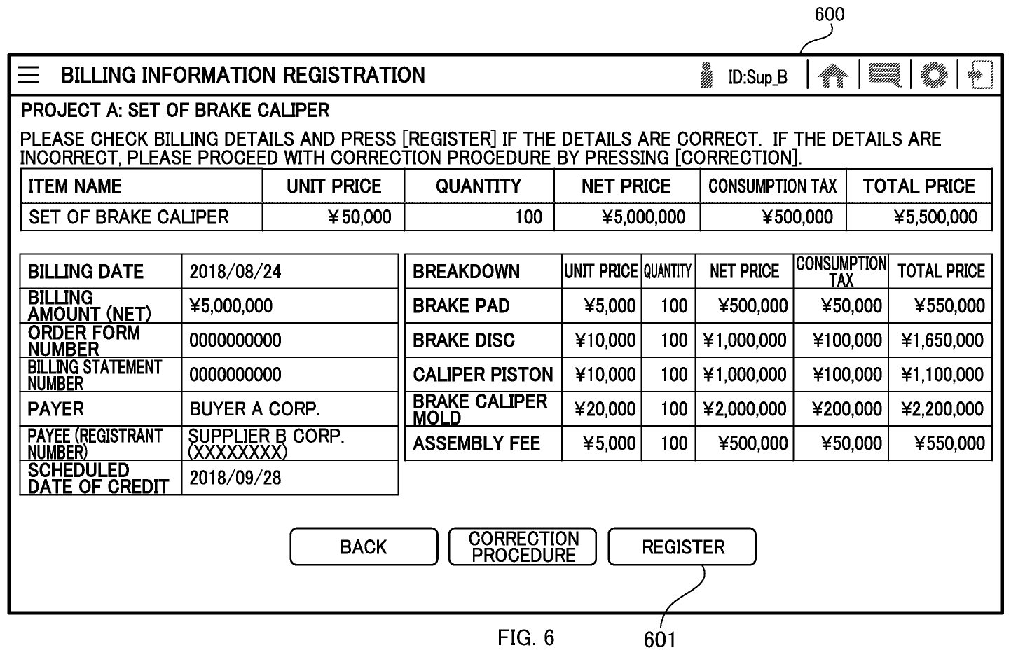

In response to the click of the registration button 501 mentioned above, the settlement operation support system 10 generates a billing statement number in accordance with a prescribed rule, for example, then generates the billing information containing values including: billing statement number “A1”; order form number “0000001”; item name “brake caliper”; quantity “500 sets”; billing amount “¥15,000,000”; payer enterprise “XX Corp.”; payee enterprise “YY Corp.”; payee's account “A Bank, B Branch, Saving Account No. xxxx”; deadline (payment due date) “2018/08/31”; and so forth, and then delivers this information to the above-mentioned supplier terminal 30 as a confirmation screen 600 for the billing information (see FIG. 6) and the like (s11).

Assume that subsequently, the above-mentioned person in charge clicks a registration button 601 for the billing statement on the above-mentioned confirmation screen 600, for example.

Meanwhile, in response to the click of the registration button 601 mentioned above, the settlement operation support system 10 issues the transaction concerning registration and issuance of the relevant billing statement concerning the order placement or acceptance action, and stores the transaction in the distributed ledger 110 after building the consensus (s12).

In the meantime, along with the issuance of this transaction in s12, the settlement operation support system 10 updates the status in the record (the record with a key “A10000001”) in the state information 112 concerning the relevant order placement or acceptance action with “billing statement issued” or the like. This processing represents completion of the registration and issuance of the billing information, that is, the billing registration.

Note that the record in the state information 112 to be updated here is assumed to have the value “A10000001”, which is obtained by merging the billing statement number “A1” and the order form number “0000001”, as the key thereof.

Meanwhile, the settlement operation support system 10 transmits notification of billing statement issuance to the buyer terminal 20 of the client “XX Corp.” included in the above-mentioned billing information (s13).

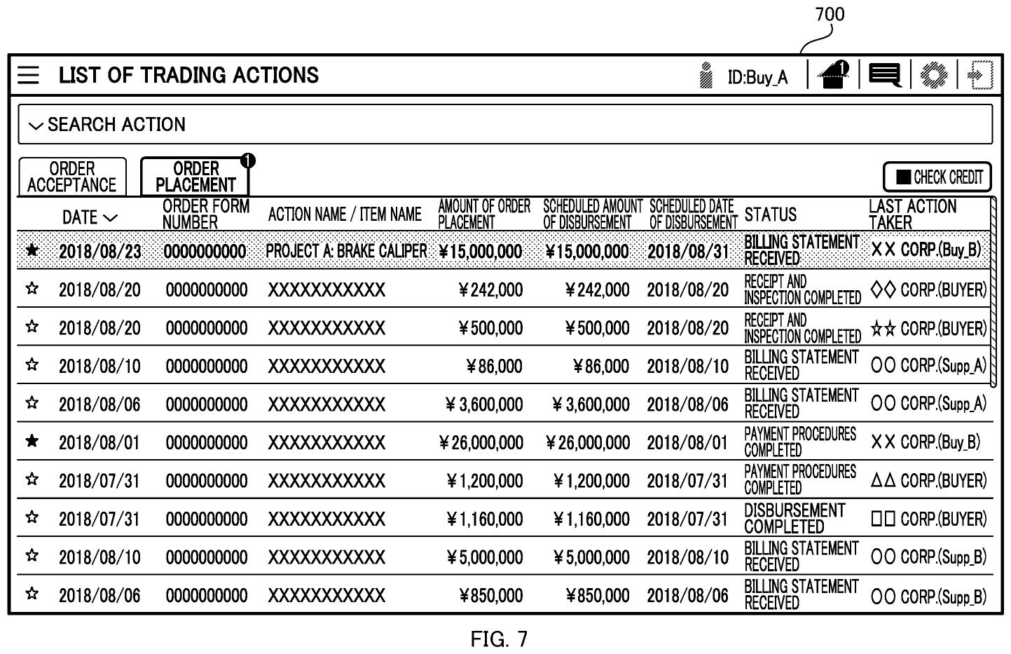

To be more precise, in response to the processing in s12 described above, for example, the settlement operation support system 10 performs highlighting control by enlarging a font size, adding an underline, changing the font into bold, changing a font color, and so forth such that a display mode of the relevant record (the record regarding the order form number “0000001”) on a list screen 700 of trading actions (see FIG. 7) being displayed on the buyer terminal 20 of the client “XX Corp.”, for instance, is different from display modes of other records so that a person in charge at the buyer enterprise can easily recognize that the status has been changed into “billing statement issued”. Alternatively, a message stating the issuance of the billing statement regarding the relevant order placement or acceptance action (the action with the order form number “0000001”) may be displayed more simply at a predetermined location on the list screen 700.

Note that this list screen 700 has the interface configuration that enables selection of one of two sheets of “order acceptance” and “order placement” by using tabs as with the list screen 400 in FIG. 4. However, in the situation mentioned above, the list screen 700 is viewed in the position of the buyer enterprise, and the list screen 700 is in the state of displaying the “order placement” sheet.

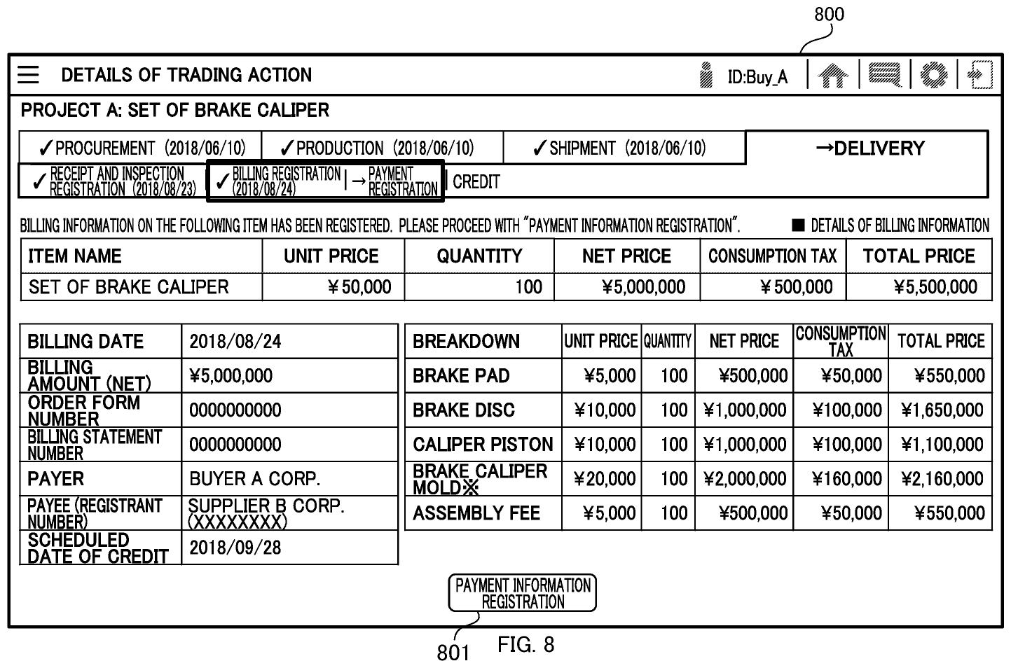

Accordingly, a person in charge (a person in charge at the buyer enterprise as for the position) who is viewing this list screen 700 clicks the relevant record, confirms details of the billing statement (FIG. 8: a confirmation screen 800 for billing details), and then clicks a registration button 801 for payment procedures by operating the buyer terminal 20.

In this case, the buyer terminal 20 notifies the settlement operation support system 10 of the clicking event.

Upon receipt of the notification, the settlement operation support system 10 instructs a financial institution system that can handle a transfer to the “payee's account” indicated in the relevant billing statement to perform transfer processing in accordance with the details indicated in the above-mentioned billing statement (s14). The financial institution system in this case corresponds to the bank system 40 or the digital currency system 50. In the above-mentioned transfer processing, it is possible to assume a case where a payer's account (the account of the buyer enterprise) and the payee's account (the account of the supplier enterprise) belong to different financial institutions, and also a case where these accounts belong to the same financial institution.

Meanwhile, the financial institution system that receives the transfer instruction transfers a prescribed amount of funds managed on behalf of the buyer enterprise to the account designated by the supplier enterprise and the like in accordance with the details of the instruction. In other words, the system executes the transfer processing. A notice of a result of this transfer processing is sent to the above-mentioned settlement operation support system 10 (and also the buyer terminal 20 as the case may be).

Nevertheless, timing (dispatch) of this transfer processing varies depending on characteristics of each financial institution. Accordingly, there are envisaged a case where the transfer processing and the notification of the result thereof are carried out instantaneously upon the instruction of the transfer processing as in the digital currency system 50, and a case where the processing is carried out in a lump in monthly batch processing and the like as in the bank system 40.

Subsequently, the settlement operation support system 10 issues a transaction concerning registration of payment information in the amount indicated in the relevant billing statement along with the above-described transfer processing, and stores the transaction in the distributed ledger after building the consensus (s15). In this case, the settlement operation support system 10 updates the status concerning the relevant billing statement in the state information 112 with “payment information registered”, “payment completed”, or the like.

Note that respective procedures concerning s15 mentioned above will be executed simultaneously with s16 to be described later depending on a mode of the transfer processing or on a mode of transfer of funds adopted by the financial institution involved in the relevant transfer processing. For example, in the case where the transfer processing is carried out on a month-end basis or the like in the mode of the batch processing, a situation is assumed in which there is a sufficient time lag between the instruction of the transfer processing and the actual transfer of funds. In this case, s15 is carried out alone. In the case of the mode of executing the transfer of fund almost immediately following the instruction of the transfer processing, the aforementioned time lag occurs very little, and accordingly, s15 and s16 will be executed simultaneously.

When the settlement operation support system 10 receives notification about the result of the transfer processing from the aforementioned financial institution system and confirms completion of the credit processing in the amount indicated in the relevant billing statement, the settlement operation support system 10 issues the transaction for credit completion concerning the settlement operation on the corresponding billing statement, and stores the transaction in the distributed ledger after building the consensus (s16). Here, it is possible to assume a situation in which the above-described series of procedures concerning the credit processing are carried out (in cooperation with an EDI function of the order placement and acceptance system 2 or the like when appropriate) while using the identification information such as the order form number and the billing statement number as a key. This configuration is deemed to be also applicable to other processing likewise.

Meanwhile, the settlement operation support system 10 updates the status concerning the billing statement in the state information 112 with “credit completed”. The above-mentioned operation to update the status in the state information 112 with “credit completed” corresponds to the reconciliation processing concerning the settlement operation on the relevant order placement or acceptance action. In other words, this operation means that the required settlement operation has been completed after undergoing the billing registration of the relevant order placement or acceptance action, the registration of the payment procedures, and the credit processing.

In the above-described example, along with the click of the button 801 for the payment procedures, the buyer terminal 20 notifies the settlement operation support system 10 of the clicking event, and the settlement operation support system 10 executes the instruction of the transfer processing.

However, instead of the aforementioned aspect, the supplier terminal 30 may execute credit confirmation processing with the above-described financial institution system that can handle the transfer to the “payee's account” via an inquiry API and the like, acquire and output a credit history to the supplier enterprise, and cause the person in charge and the like at the supplier to confirm the transfer processing in accordance with the details indicated in the relevant billing statement. In this case, the supplier terminal 30 notifies the settlement operation support system of a result of the credit confirmation (a result of successful confirmation of the credit) by the above-mentioned person in charge and the like. Meanwhile, upon receipt thereof, the settlement operation support system 10 performs the processing including the issuance of the transaction for credit completion concerning the settlement operation on the corresponding billing statement, and the storage of the transaction in the distributed ledger. This aspect is effective in a situation where the financial institution does not open the API concerning the transfer processing to the settlement operation support system 10 and the transfer processing by the buyer enterprise can only be confirmed by way of an inquiry through the supplier terminal 30.

Meanwhile, in s13 of the above-described processing, it is also possible to envisage a case in which the person in charge at the buyer enterprise clicks the relevant record on the list screen 700 (FIG. 7) on the buyer terminal 20 to which the notification of the issuance of the billing statement is transmitted, confirms the details of the billing statement (FIG. 8: the confirmation screen 800 for the billing details), designates a desired payment method, and clicks the button 801 for the payment procedures.

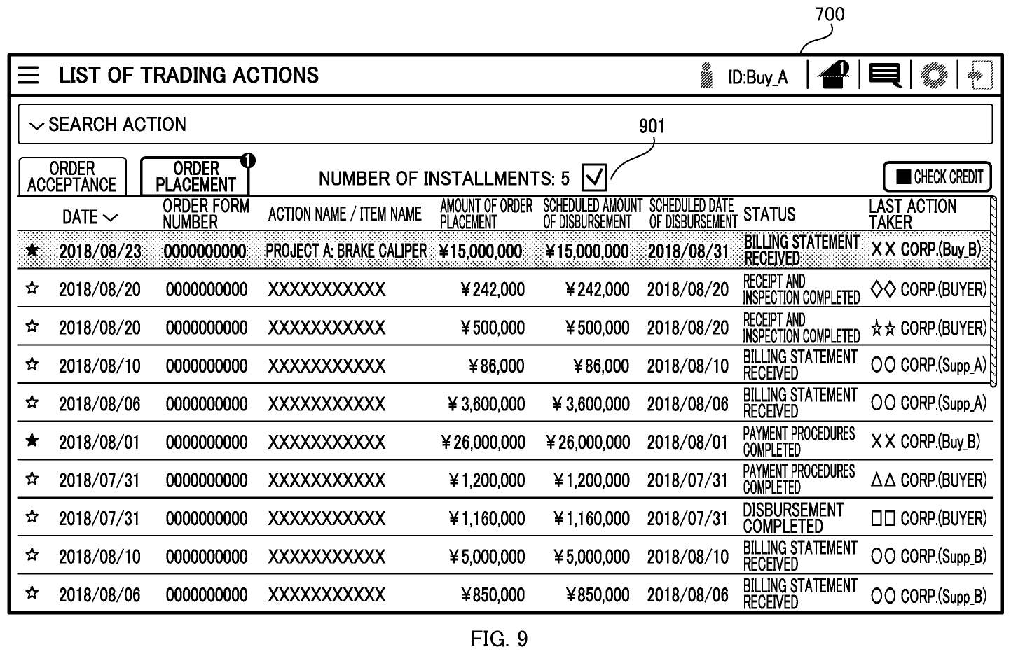

For example, assume that the above-mentioned person in charge designates payment in installments in a predetermined number of times as a desired payment method by using a check box 901 (see FIG. 9) serving as an interface on the list screen 700 and then clicks the button 801. Then, the buyer terminal 20 accepting this operation notifies the settlement operation support system 10 of a value representing the designated detail on the interface 901. Note that the above-mentioned number of installments is determined in advance by way of a prescribed contract or the order placement and acceptance between the buyer enterprise and the supplier enterprise, and the designating operation by the person in charge corresponds to an act of wishing that condition by using the above-mentioned check box 901. However, the invention is not limited only to this configuration, and it is also possible to assume a case in which the buyer enterprise is entitled to designate the number of installments in each case.

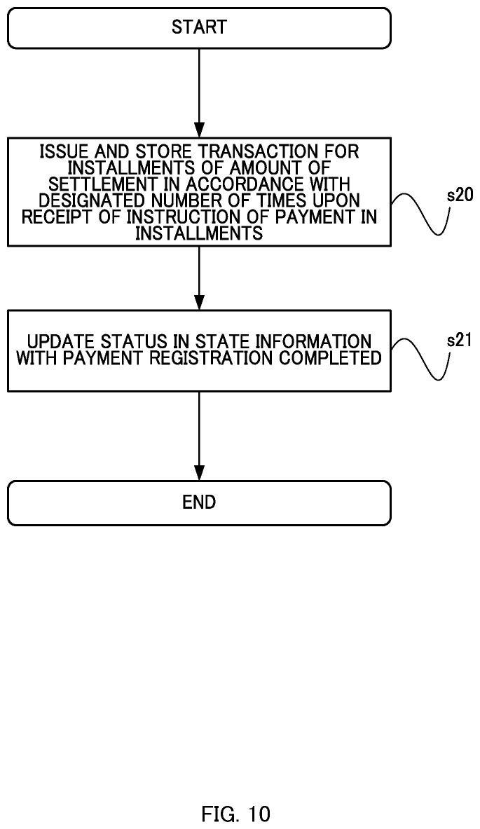

In this case, as shown in a flow in FIG. 10, the settlement operation support system 10 issues a transaction concerning the payment procedures in the number of times corresponding to the designated number of times each in an amount obtained by dividing an amount of settlement indicated in the relevant record (the billing registration) by the designated number of times, and stores the transaction in the distributed ledger 110 after building the consensus (s20).

Meanwhile, along with s20, the settlement operation support system 10 updates the status concerning the relevant billing statement in the state information 112 with “payment registration completed” (s21), and terminates this flow. As for processing to follow, display of relevant records (records in the number of installments corresponding to the designated number of times) in the “order placement” sheet on the list screen 700, the transfer processing upon acceptance of the click of the button 801 for the payment procedures corresponding thereto, and the like will be executed likewise.

In the meantime, in s13 of the above-described processing, it is also possible to envisage a case in which the desired payment method designated by the person in charge at the buyer enterprise with the buyer terminal 20, to which the notification of the issuance of the billing statement is transmitted, is lump-sum payment instead of the payment in installments.

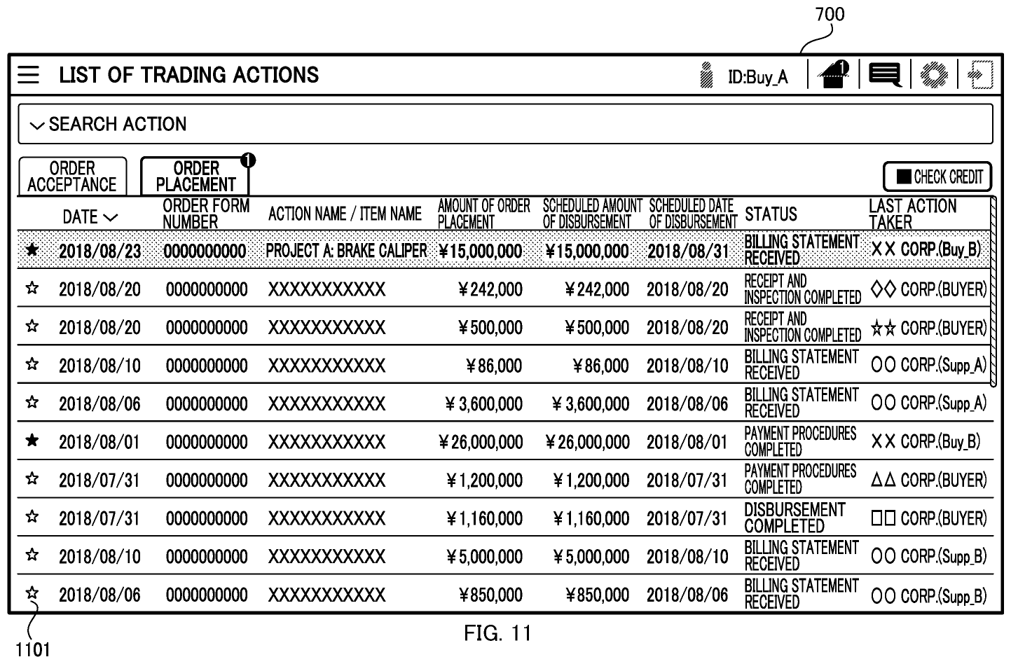

For example, assume that the above-mentioned person in charge designates the lump-sum payment by summing up two or more billing statements as the desired payment method on an interface 1101 (see star-shaped objects in FIG. 11) on the list screen 700 and clicks the button 801. Then, the buyer terminal 20 accepting this operation notifies the settlement operation support system 10 of a value representing the designated detail on the interface 901.

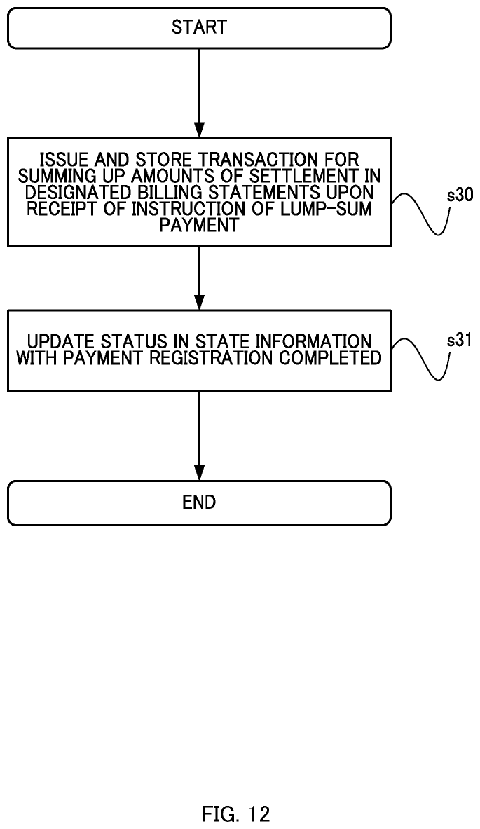

In this case, as shown in a flow in FIG. 12, the settlement operation support system 10 issues a transaction concerning the payment procedures in an amount obtained by summing up amounts of settlement indicated in the respective target records (the billing registrations), and stores the transaction in the distributed ledger 110 after building the consensus (s30).

Meanwhile, along with s30, the settlement operation support system 10 updates the status concerning each of the relevant billing statements in the state information 112 with “payment registration completed” (s31), and terminates this flow. As for the processing to follow, display of a relevant record (a record obtained by unifying the details of the billing statements) in the “order placement” sheet of the list screen 700, the transfer processing upon acceptance of the click of the button 801 for the payment procedures corresponding thereto, and the like will be executed likewise.

The best mode and the like for carrying out the present invention have been specifically described above. It is to be noted, however, that the present invention is not limited to the foregoing and various changes are possible within the range not departing from the gist thereof.

The above-described embodiment appropriately supports the settlement operation triggered by the status of receipt and inspection along with the order placement and acceptance operation on the existing service platform. For example, in the course of the billing registration and the payment operation corresponding to the billing, the respective statuses from the billing to the reconciliation can be shared between the related parties in real time. This handling is realized in the form of service offering by using the distributed ledger technology (the blockchain) as the platform. Therefore, authenticity or completeness of various data concerning the aforementioned billing, payment, and the like is guaranteed, thus rendering reliability of the final reconciliation processing favorable as well.

Meanwhile, preparation, storage, and management of billing statements in compliance with revisions and the like of legal systems such as a taxation system (the method of storing eligible invoices, for example) can be appropriately handled by the system side, so that the service can be introduced and applied easily while avoiding a burden on a user side.

Accordingly, it is possible to manage the status of the prescribed event concerning the settlement operation thoroughly, efficiently, and with proper instantaneity between the related parties, thereby improving efficiency of the settlement operation.

At least the following features are made clear from the present description. Specifically, in the settlement operation support system of this embodiment, the prescribed node may execute processing to acquire information on a credit event concerning a prescribed account from a prescribed financial institution system upon receipt of a credit confirmation instruction from a user or in accordance with a status of a payment procedure of the amount of settlement in the state information, processing to issue a transaction concerning credit of the amount of settlement in a case where the information indicates the credit of the amount of settlement of the order placement or acceptance action, and to store the transaction in the distributed ledger after building the consensus, and processing to update a status of the amount of settlement in the state information with credit completed.

According to this configuration, the status of credit of the amount of settlement is checked on the operation support system side. Hence, it is possible to properly judge the trigger for the reconciliation processing depending on this result and to carry out the processing. Eventually, it is possible to manage the status of the prescribed event concerning the settlement operation thoroughly, efficiently, and with proper instantaneity between the related parties, thereby further improving efficiency of the settlement operation.

Meanwhile, in the settlement operation support system of this embodiment, the prescribed node may determine a status of each procedure in the settlement operation associated with an order placement or acceptance action of any of a prescribed organization satisfying a predetermined condition and an organization operating the prescribed node by referring to the state information, and display the status of each procedure on an output unit.

According to this configuration, each organization such as the buyer and the supplier can reliably and easily check the status concerning the settlement operation of the order placement or acceptance action which this organization is involved in, thus leading to a capability of properly performing the respective procedures necessary for carrying out the settlement operation. Eventually, it is possible to manage the status of the prescribed event concerning the settlement operation thoroughly, efficiently, and with proper instantaneity between the related parties, thereby further improving efficiency of the settlement operation.

Meanwhile, in the settlement operation support system of this embodiment, in a case where the prescribed node receives a user instruction to carry out a payment registration concerning a certain procedure out of the procedures of which statuses are displayed on the output unit, the certain procedure representing billing registration processing with a status indicated as completed, the prescribed node may issue a transaction concerning a payment procedure in the amount of settlement indicated in the billing registration, store the transaction in the distributed ledger after building the consensus, and update the status of the payment procedure in the state information with payment registration completed.

According to this configuration, the registration of the payment procedures is thoroughly executed by the user who recognizes the completion of the billing registration, and the status is managed as well. Eventually, it is possible to manage the status of the prescribed event concerning the settlement operation thoroughly, efficiently, and with proper instantaneity between the related parties, thereby further improving efficiency of the settlement operation.

Meanwhile, in the settlement operation support system of this embodiment, in a case where the prescribed node receives a user instruction to perform payment in installments in a prescribed number of times concerning the certain procedure out of the procedures of which statuses are displayed on the output unit, the certain procedure representing the billing registration processing with the status indicated as completed, the prescribed node may issue a transaction concerning the payment procedures in the number of times corresponding to the prescribed number of times each in an amount obtained by dividing the amount of settlement indicated in the billing registration by the prescribed number of times, store the transaction in the distributed ledger after building the consensus, and update the status of the payment procedures in the state information with payment registration completed.

According to this configuration, the amount of settlement indicated in the billing registration can be subjected to payment in installments and it is possible to carry out the settlement operation according to the needs of each organization. Eventually, it is possible to manage the status of the prescribed event concerning the settlement operation thoroughly, efficiently, and with proper instantaneity between the related parties, thereby further improving efficiency of the settlement operation.

Meanwhile, in the settlement operation support system of this embodiment, in a case where the prescribed node receives a user instruction to perform lump-sum payment of a prescribed group of the order placement or acceptance actions concerning the certain procedure out of the procedures concerning the order placement or acceptance actions of which statuses are displayed on the output unit, the certain procedure representing the billing registration processing with the status indicated as completed, the prescribed node may issue a transaction concerning the payment procedure in an amount obtained by summing up the amounts of settlement of the respective order placement or acceptance actions forming the group of the order placement or acceptance actions, store the transaction in the distributed ledger after building the consensus, and update the status of the payment procedures in the state information with payment registration completed.

According to this configuration, the billing registrations concerning two or more order placement or acceptance actions can be subjected to the lump-sum payment and it is possible to carry out the settlement operation according to the needs of each organization. Eventually, it is possible to manage the status of the prescribed event concerning the settlement operation thoroughly, efficiently, and with proper instantaneity between the related parties, thereby further improving efficiency of the settlement operation.

Meanwhile, in the settlement operation support system of this embodiment, a specific node determined in advance out of the nodes of the distributed ledger system may execute the reconciliation processing, the processing to acquire the information on the credit event, the processing to issue the transaction concerning the credit of the amount of settlement and to store the transaction in the distributed ledger after building the consensus, and the processing to update the status of the amount of settlement in the state information with credit completed.

According to this configuration, it is possible to allocate roles appropriately between the node (the distributed ledger node) of each participant enterprise and the specific node (a settlement system) of an enterprise operating the distributed ledger system and the like in the distributed ledger system, whereby the settlement operation support method can be carried out with the configuration to allow the specific node to perform specific processing such as the reconciliation processing. Eventually, it is possible to manage the status of the prescribed event concerning the settlement operation thoroughly, efficiently, and with proper instantaneity between the related parties, thereby further improving efficiency of the settlement operation.

In the meantime, in the settlement operation support method of this embodiment, the prescribed node may execute processing to acquire information on a credit event concerning a prescribed account from a prescribed financial institution system upon receipt of a credit confirmation instruction from a user or in accordance with a status of a payment procedure of the amount of settlement in the state information, processing to issue a transaction concerning credit of the amount of settlement in a case where the information indicates the credit of the amount of settlement of the order placement or acceptance action, and to store the transaction in the distributed ledger after building the consensus, and processing to update a status of the amount of settlement in the state information with credit completed.

Meanwhile, in the settlement operation support method of this embodiment, the prescribed node may determine a status of each procedure in the settlement operation associated with an order placement or acceptance action of any of a prescribed organization satisfying a predetermined condition and an organization operating the prescribed node by referring to the state information, and display the status of each procedure on an output unit.

Meanwhile, in the settlement operation support method of this embodiment, in a case where the prescribed node receives a user instruction to carry out a payment registration concerning a certain procedure out of the procedures of which statuses are displayed on the output unit, the certain procedure representing billing registration processing with a status indicated as completed, the prescribed node may issue a transaction concerning a payment procedure in the amount of settlement indicated in the billing registration, store the transaction in the distributed ledger after building the consensus, and update the status of the payment procedure in the state information with payment registration completed.

Meanwhile, in the settlement operation support method of this embodiment, in a case where the prescribed node receives a user instruction to perform payment in installments in a prescribed number of times concerning the certain procedure out of the procedures of which statuses are displayed on the output unit, the certain procedure representing the billing registration processing with the status indicated as completed, the prescribed node may issue a transaction concerning the payment procedures in the number of times corresponding to the prescribed number of times each in an amount obtained by dividing the amount of settlement indicated in the billing registration by the prescribed number of times, store the transaction in the distributed ledger after building the consensus, update the status of the payment procedures in the state information with payment registration completed.

Meanwhile, in the settlement operation support method of this embodiment, in a case where the prescribed node receives a user instruction to perform lump-sum payment of a prescribed group of the order placement or acceptance actions concerning the certain procedure out of the procedures concerning the order placement or acceptance actions of which statuses are displayed on the output unit, the certain procedure representing the billing registration processing with the status indicated as completed, the prescribed node may issue a transaction concerning the payment procedure in an amount obtained by summing up the amounts of settlement of the respective order placement or acceptance actions forming the group of the order placement or acceptance actions, store the transaction in the distributed ledger after building the consensus, and update the status of the payment procedures in the state information with payment registration completed.

Meanwhile, in the settlement operation support method of this embodiment, a specific node determined in advance out of the nodes of the distributed ledger system may execute the reconciliation processing, the processing to acquire the information on the credit event, the processing to issue the transaction concerning the credit of the amount of settlement and to store the transaction in the distributed ledger after building the consensus, and the processing to update the status of the amount of settlement in the state information with credit completed.

### REFERENCE SIGNS LIST

1 network
2 order placement and acceptance system (service platform)
5 distributed ledger system
10 settlement operation support system
11 storage unit
12 program
13 memory
14 computation unit
15 communication unit
110 distributed ledger
111 blockchain
112 state information
113 smart contract
20 buyer terminal
30 supplier terminal
40 bank system
50 digital currency system

1. A settlement operation support system for a distributed ledger system including a plurality of nodes representing a plurality of organizations, respectively, at least a prescribed node out of the nodes comprising:
a storage unit configured to store a distributed ledger; and
a computation unit configured to execute
processing to receive a transaction for a settlement operation associated with order placement and acceptance between prescribed organizations out of the organizations, and to store the transaction in the distributed ledger after building a prescribed consensus in the distributed ledger system,
processing to manage a status in each of procedures in the settlement operation as state information of the distributed ledger, and
processing to perform reconciliation processing of a relevant order placement or acceptance action in a case where a status of an amount of settlement in the state information becomes credit completed.

2. The settlement operation support system according to claim 1, wherein
the prescribed node executes
processing to acquire information on a credit event concerning a prescribed account from a prescribed financial institution system upon receipt of a credit confirmation instruction from a user or in accordance with a status of a payment procedure of the amount of settlement in the state information,
processing to issue a transaction concerning credit of the amount of settlement in a case where the information indicates the credit of the amount of settlement of the order placement or acceptance action, and to store the transaction in the distributed ledger after building the consensus, and
processing to update a status of the amount of settlement in the state information with credit completed.

3. The settlement operation support system according to claim 2, wherein
the prescribed node determines a status of each procedure in the settlement operation associated with an order placement or acceptance action of any of a prescribed organization satisfying a predetermined condition and an organization operating the prescribed node by referring to the state information, and displays the status of each procedure on an output unit.

4. The settlement operation support system according to claim 3, wherein
in a case where the prescribed node receives a user instruction to carry out a payment registration concerning a certain procedure out of the procedures of which statuses are displayed on the output unit, the certain procedure representing billing registration processing with a status indicated as completed, the prescribed node issues a transaction concerning a payment procedure in the amount of settlement indicated in the billing registration, stores the transaction in the distributed ledger after building the consensus, and updates the status of the payment procedure in the state information with payment registration completed.

5. The settlement operation support system according to claim 4, wherein
in a case where the prescribed node receives a user instruction to perform payment in installments in a prescribed number of times concerning the certain procedure out of the procedures of which statuses are displayed on the output unit, the certain procedure representing the billing registration processing with the status indicated as completed, the prescribed node issues a transaction concerning the payment procedures in the number of times corresponding to the prescribed number of times each in an amount obtained by dividing the amount of settlement indicated in the billing registration by the prescribed number of times, stores the transaction in the distributed ledger after building the consensus, and updates the status of the payment procedures in the state information with payment registration completed.

6. The settlement operation support system according to claim 4, wherein
in a case where the prescribed node receives a user instruction to perform lump-sum payment of a prescribed group of the order placement or acceptance actions concerning the certain procedure out of the procedures concerning the order placement or acceptance actions of which statuses are displayed on the output unit, the certain procedure representing the billing registration processing with the status indicated as completed, the prescribed node issues a transaction concerning the payment procedure in an amount obtained by summing up the amounts of settlement of the respective order placement or acceptance actions forming the group of the order placement or acceptance actions, stores the transaction in the distributed ledger after building the consensus, and updates the status of the payment procedures in the state information with payment registration completed.

7. The settlement operation support system according to claim 2, wherein
a specific node determined in advance out of the nodes of the distributed ledger system executes
the reconciliation processing,
the processing to acquire the information on the credit event,
the processing to issue the transaction concerning the credit of the amount of settlement and to store the transaction in the distributed ledger after building the consensus, and
the processing to update the status of the amount of settlement in the state information with credit completed.

8. A settlement operation support method for a distributed ledger system including a plurality of nodes representing a plurality of organizations, respectively, in which at least a prescribed node out of the nodes includes a storage unit configured to store a distributed ledger,
the method comprising executing, in the prescribed node:
processing to receive a transaction for a settlement operation associated with order placement and acceptance between prescribed organizations out of the organizations, and to store the transaction in the distributed ledger after building a prescribed consensus in the distributed ledger system,
processing to manage a status in each of procedures in the settlement operation as state information of the distributed ledger, and
processing to perform reconciliation processing of a relevant order placement or acceptance action in a case where a status of an amount of settlement in the state information becomes credit completed.

9. The settlement operation support method according to claim 8, wherein
the prescribed node executes
processing to acquire information on a credit event concerning a prescribed account from a prescribed financial institution system upon receipt of a credit confirmation instruction from a user or in accordance with a status of a payment procedure of the amount of settlement in the state information,
processing to issue a transaction concerning credit of the amount of settlement in a case where the information indicates the credit of the amount of settlement of the order placement or acceptance action, and to store the transaction in the distributed ledger after building the consensus, and
processing to update a status of the amount of settlement in the state information with credit completed.

10. The settlement operation support method according to claim 9, wherein
the prescribed node determines a status of each procedure in the settlement operation associated with an order placement or acceptance action of any of a prescribed organization satisfying a predetermined condition and an organization operating the prescribed node by referring to the state information, and displays the status of each procedure on an output unit.

11. The settlement operation support method according to claim 10, wherein
in a case where the prescribed node receives a user instruction to carry out a payment registration concerning a certain procedure out of the procedures of which statuses are displayed on the output unit, the certain procedure representing billing registration processing with a status indicated as completed, the prescribed node issues a transaction concerning a payment procedure in the amount of settlement indicated in the billing registration, stores the transaction in the distributed ledger after building the consensus, and updates the status of the payment procedure in the state information with payment registration completed.

12. The settlement operation support method according to claim 11, wherein
in a case where the prescribed node receives a user instruction to perform payment in installments in a prescribed number of times concerning the certain procedure out of the procedures of which statuses are displayed on the output unit, the certain procedure representing the billing registration processing with the status indicated as completed, the prescribed node issues a transaction concerning the payment procedures in the number of times corresponding to the prescribed number of times each in an amount obtained by dividing the amount of settlement indicated in the billing registration by the prescribed number of times, stores the transaction in the distributed ledger after building the consensus, and updates the status of the payment procedures in the state information with payment registration completed.

13. The settlement operation support method according to claim 11, wherein
in a case where the prescribed node receives a user instruction to perform lump-sum payment of a prescribed group of the order placement or acceptance actions concerning the certain procedure out of the procedures concerning the order placement or acceptance actions of which statuses are displayed on the output unit, the certain procedure representing the billing registration processing with the status indicated as completed, the prescribed node issues a transaction concerning the payment procedure in an amount obtained by summing up the amounts of settlement of the respective order placement or acceptance actions forming the group of the order placement or acceptance actions, stores the transaction in the distributed ledger after building the consensus, and updates the status of the payment procedures in the state information with payment registration completed.

14. The settlement operation support method according to claim 9, wherein
a specific node determined in advance out of the nodes of the distributed ledger system executes
the reconciliation processing,
the processing to acquire the information on the credit event,
the processing to issue the transaction concerning the credit of the amount of settlement and to store the transaction in the distributed ledger after building the consensus, and
the processing to update the status of the amount of settlement in the state information with credit completed.
